(19) United States
(12) Patent Application Publication
(10) Pub. No.: US 2025/0212703 A1
(43) Pub. Date: Jun. 26, 2025

(54) METHODS AND SYSTEMS FOR ESTIMATING LOCALIZATION LENGTHS IN HYBRID SUPERCONDUCTOR-SEMICONDUCTOR QUANTUM DEVICES

(71) Applicant: Microsoft Technology Licensing, LLC, Redmond, WA (US)

(72) Inventors: Firas HAMZE, Vancouver (CA); Dmitry PIKULIN, Vancouver (CA); Tom Marijn LAEVEN, Delft (NL); Roman Mykolayovych LUTCHYN, Santa Barbara, CA (US); Kevin Alexander VAN HOOGDALEM, Alphen aan den Rijn (NL); Andrey ANTIPOV, Santa Barbara, CA (US)

(21) Appl. No.: 18/417,640

(22) Filed: Jan. 19, 2024

Related U.S. Application Data
(60) Provisional application No. 63/613,502, filed on Dec. 21, 2023.

(51) Int. Cl. H10N 60/82; G01R 33/12; H10N 60/10

(52) U.S. Cl. CPC H10N 60/82; H10N 60/10; G01R 33/1238

(57) ABSTRACT

Methods and systems for estimating localization lengths in hybrid superconductor-semiconductor quantum devices are described. A method for estimating localization lengths in a hybrid superconductor-semiconductor quantum device includes constructing a statistical model for extracting localization lengths based on an implicit description of nonlocal conductance measurements associated with a physical representation of the hybrid superconductor-semiconductor quantum device. The method further includes, using a processor, estimating the localization lengths in the hybrid superconductor-semiconductor quantum device by a joint prior distribution enforcing smoothness over a function of gate voltages and extracted localization lengths for the hybrid superconductor-semiconductor quantum device.

### CROSS-REFERENCE TO A RELATED APPLICATION

This application claims the benefit of U.S. Provisional Application No. 63/613,502, filed Dec. 21, 2023, titled “METHODS AND SYSTEMS FOR ESTIMATING LOCALIZATION LENGTHS IN HYBRID SUPERCONDUCTOR-SEMICONDUCTOR QUANTUM DEVICES,” the entire contents of which are hereby incorporated herein by reference.

### BACKGROUND

Hybrid superconductor-semiconductor quantum devices having superconducting wires can have segments with one of two phases: a trivial phase or a topological phase. Such devices are optimized to produce a large topological gap. To achieve the large topological gap, the semiconductor stack in such devices needs to produce a large spin-orbit coupling in the confined two-dimensional gas (2DEG). Disorder in the bulk of such superconducting wires suppresses the topological gap and increases the coherence length. This, in turn, leads to a minimum length requirement for the superconducting wire to perform well as a part of a qubit that depends on the composition/geometry of the stack of layers used to form the wire and the disorder level.

In such hybrid superconductor-semiconductor quantum devices, localization length is a parameter that determines the statistical dependence of conductance on the length of the device. In principle, the measurement of the conductance for a set of device lengths should enable estimation of the localization length. In practice, the measurements of conductance are corrupted by noise. Accordingly, there is a need for improved systems and methods for estimating localization lengths in hybrid superconductor-semiconductor quantum devices.

### SUMMARY

In one example, the present disclosure relates to a method for estimating localization lengths in a hybrid superconductor-semiconductor quantum device. The method may include constructing a statistical model for extracting localization lengths based on an implicit description of nonlocal conductance measurements associated with a physical representation of the hybrid superconductor-semiconductor quantum device.

The method may further include, using a processor, estimating the localization lengths in the hybrid superconductor-semiconductor quantum device by a joint prior distribution enforcing smoothness over a function of gate voltages and extracted localization lengths for the hybrid superconductor-semiconductor quantum device.

In another example, the present disclosure relates to a non-transitory computer-readable medium comprising instructions for a method for estimating localization lengths in a hybrid superconductor-semiconductor quantum device. The method may include constructing a statistical model for extracting localization lengths based on an implicit description of measurements associated with a physical representation of the hybrid superconductor-semiconductor quantum device, where the measurements associated with the physical representation of the hybrid superconductor-semiconductor quantum device comprise physical measurements of nonlocal conductance values for a set of device lengths.

The method may further include using a processor, estimating the localization lengths in the hybrid superconductor-semiconductor quantum device by a joint prior distribution enforcing smoothness over a function of gate voltages and extracted localization lengths for the hybrid superconductor-semiconductor quantum device.

In yet another example, the present disclosure relates to a method for estimating localization lengths in a hybrid superconductor-semiconductor quantum device. The method may include constructing a statistical model for extracting localization lengths based on an implicit description of measurements associated with a physical representation of the hybrid superconductor-semiconductor quantum device.

The method may further include using a processor, estimating the localization lengths in the hybrid superconductor-semiconductor quantum device by a joint prior distribution enforcing smoothness over a function of gate voltages and extracted localization lengths for the hybrid superconductor-semiconductor quantum device. The method may further include characterizing a level of disorder in the hybrid superconductor-semiconductor quantum device using the estimated localization lengths.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of a computing system for estimating localization lengths in hybrid superconductor-semiconductor quantum devices in accordance with one example;

FIG. 2 shows a schematic diagram of a hybrid superconductor-semiconductor quantum device with multiple gate-defined sections of different lengths for measuring nonlocal conductance values;

FIG. 3 shows plots of the measured nonlocal conductance values versus the plunger voltage and the bias voltage for different physical length segments in accordance with one example;

FIG. 4 shows a graph of the extracted localization lengths as a function of the plunger voltage;

FIG. 5 shows a graph of extracted localization lengths and a graph of the log of the extracted localization lengths;

FIG. 6 shows a graph created with synthetic data to illustrate the effect of the mean path prior smoothing;

FIG. 7 shows a graph illustrating the validation losses for log values of the constraint parameter used as part of the smoothing;

FIG. 8 shows a graph illustrating the estimated localization length using the Max a Posteriori (MAP) function versus the plunger voltage scan using a selected value for the constraint parameter;

FIG. 9 shows a flow chart of a method for estimating localization lengths in hybrid superconductor-semiconductor quantum devices in accordance with one example;

FIG. 10 shows a graph comparing the smoothed and the validated localization lengths with the localization lengths obtained from a physics-based simulator;

FIG. 11 shows a graph comparing the localization lengths obtained using an independent Max a Posteriori (MAP) function (without the smoothing and validation) with the localization lengths obtained from a physics-based simulator; and

FIG. 12 shows a flow chart of a method for characterizing a level of disorder in hybrid superconductor-semiconductor quantum devices in accordance with one example.

### DETAILED DESCRIPTION

The present disclosure relates to systems and methods for estimating localization lengths in hybrid superconductor-semiconductor quantum devices. As noted earlier, hybrid superconductor-semiconductor quantum devices with superconducting wires can have segments with one of two phases: a trivial phase or a topological phase. Such topological hybrid superconductor-semiconductor quantum devices are optimized to produce a large topological gap. To achieve the large topological gap, the semiconductor stack in such devices needs to produce a large spin-orbit coupling in the confined two-dimensional gas (2DEG). Disorder in the bulk of such superconducting wires suppresses the topological gap and increases the coherence length. This, in turn, leads to a minimum length requirement for the superconducting wire to perform well as a part of a qubit that depends on the composition/geometry of the stack of layers used to form the wire and the disorder level.

In such quantum devices, localization length (LL) is a parameter that determines the statistical dependence of conductance on the length of the device. In principle, the measurement of the conductance for a set of device lengths should enable estimation of the LL. In practice, the measurements of conductance are corrupted by noise. The methods described herein can be used for accurately estimating localization lengths in hybrid superconductor-semiconductor quantum devices.

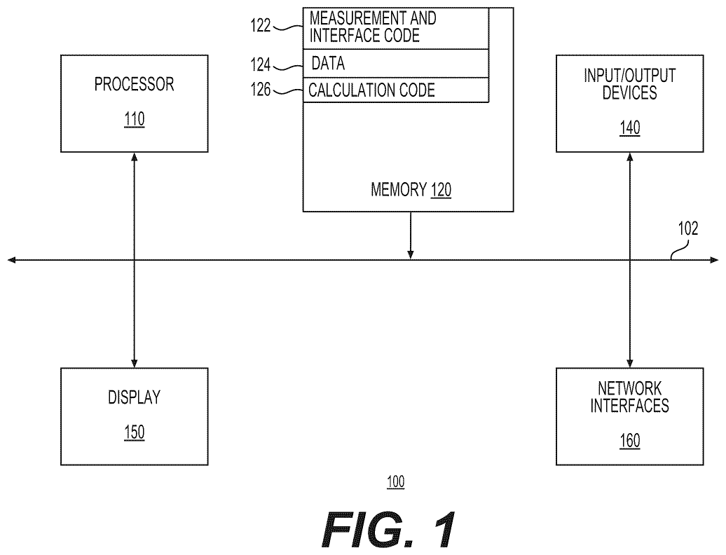

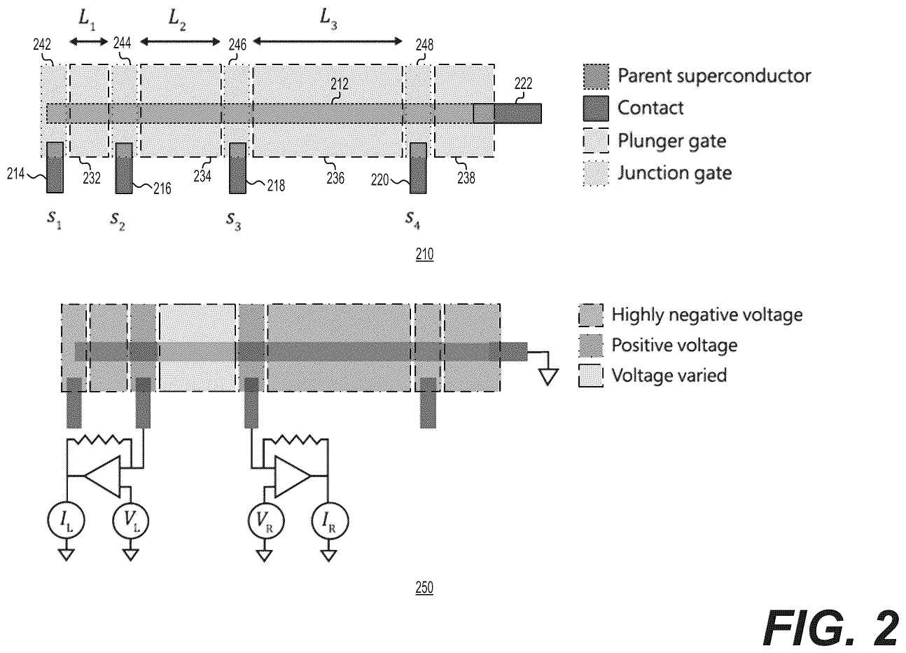

FIG. 1 is a block diagram of a computing system 100 for estimating localization lengths in hybrid superconductor-semiconductor quantum devices in accordance with one example. Computing system 100 includes a processor 110, a memory 120, input/output devices 140, display 150, and network interfaces 160 interconnected via bus system 102. Memory 120 may include measurement and interface code 122, data 124 (including measurement data, synthetic data, or other types of data used as part of the methods described herein), and calculation code 126. Measurement and interface code 122 may include program instructions that, when executed by processor 110, allow computing system 100 to enable the performance of the methods described herein, including the various aspects of the methods described with respect to FIGS. 2-12. In addition, measurement and interface code 122 may include libraries or other code for allowing processor 110 to display relevant information on display 150. Measurement and interface code 122 may also allow input/output devices 140 to receive or transmit information associated with the methods described herein. As an example, computing system 100 may access data concerning hybrid superconductor-semiconductor quantum devices via input/output devices 140 with the help of the execution of the measurement and interface code 122. Measurement and interface code 122 may also operate in conjunction with an experimental set up to allow a user to control the various knobs (e.g., plunger voltage or other voltages) associated with the measurement of the local conductance values.

Calculation code 126 may include instructions for executing steps described with respect to the various methods described herein. As an example, calculation code 126 may include software libraries and other code for extracting localization lengths, estimating the localization lengths, including smoothing, and cross-validating as described later. Although FIG. 1 shows a certain number of components of computing system 100 arranged in a certain way, additional or fewer components arranged differently may also be used. In addition, although memory 120 shows certain blocks of code, the functionality provided by this code may be combined or distributed. In addition, the various blocks of code may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory, such as DRAM, SRAM, a cache, or other such media.

FIG. 2 shows a schematic diagram of a device layout 210 of a hybrid superconductor-semiconductor quantum device with multiple gate-defined sections of different lengths for measuring nonlocal conductance values. FIG. 2 further shows a measurement configuration 250 to measure conductance of one of the sections of different lengths. Device layout 210 shows parent superconductor 212 under both plunger gates 232, 234, 236, and 238 and junction gates 242, 244, 246, and 248. Parent superconductor 212 is coupled to a parent superconductor contact 222. Device layout 210 shows three gate-defined sections with lengths of L₁, L₂, and L₃. The superconductor is underneath plunger gates and junction gates. Sources (S1, S2, S3, and S4) are configured to contact the semiconductor quantum well via contacts 214, 216, 218, and 220. Coupling to parent superconductor 212 is controlled by junction gates 242, 244, 246, and 248. Device layout 210 corresponds to a physical representation of the hybrid superconductor-semiconductor quantum device. The physical representation of the hybrid superconductor-semiconductor quantum device may be a device under test or any other device formed on a single integrated circuit using semiconductor/superconductor fabrication techniques.

The measurement configuration 250 is configured to measure conductance of a single section. The junction gates for the section under measurement are set to a positive voltage to contact the semiconductor. For this device layout 210, by measuring the conductance values between sources S3 and S4, the conductance values for one length of the wire (e.g., L=1 μm) are obtained. The plunger gate of this section will be varied during the measurement and all other gates are set to highly negative voltages to deplete all unwanted semiconductor states. The nonlocal conductance is then measured with the nanowire (the superconductor) grounded. This measurement is then repeated for all sections of the nanowire. As an example, by measuring the conductance values between sources S2 and S3, the conductance values for another length of the wire (e.g., L=2 μm) are obtained. Similarly, by measuring the conductance values between sources S2 and S4, the conductance values for another length of the wire (e.g., L=3.5 μm) are obtained. By measuring the conductance values between sources S1 and S3, the conductance for another length of the wire (e.g., L=6.5 μm) are obtained. Finally, by measuring the conductance values between sources S1 and S4, the conductance values for another length of the wire (e.g., L=8 μm) are obtained.

The plunger gates and the junction gates described herein may be supplied voltages via voltage waveforms generated by a control system (not shown) associated with the hybrid superconductor-semiconductor quantum device. Such a control system may include oscillators, switches, finite state machines, and a memory. As an example, the memory may be implemented as one or more multi-bit registers for allowing scan-patterns and pulse-patterns to be stored. Although FIG. 2 shows a certain device layout 210 and a corresponding measurement configuration 250, other device layouts and measurement configurations can also be used to measure nonlocal conductance values. In addition, although FIG. 2 describes the measurement of the conductance values for wires with lengths between 1 μm to 8 μm, the measurement of conductance values for devices having other layouts with different physical length wire-sections can also be performed.

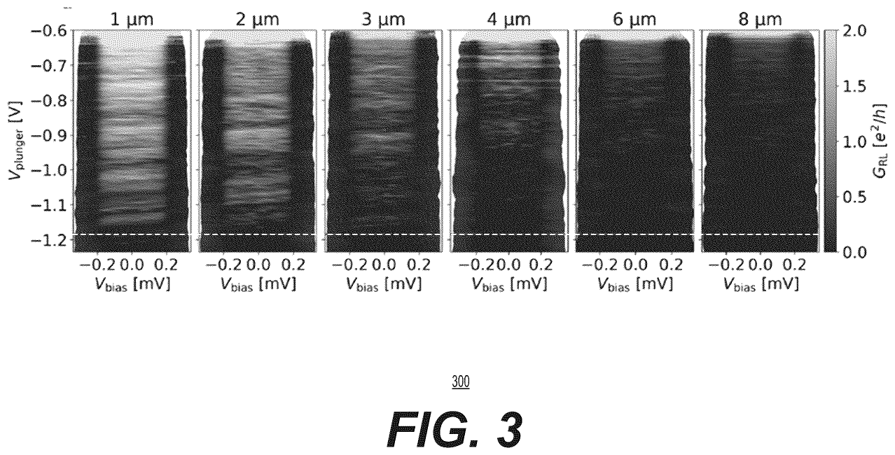

FIG. 3 shows plots 300 of the measured nonlocal conductance values versus the plunger voltage and the bias voltage for different physical length segments in accordance with one example. Hybrid superconductor-semiconductor quantum devices can be implemented using superconductor-semiconductor nanowires with a sufficiently long localization length, as required for a topological phase. Plots 300 are derived from the experimental hybrid mobility device (device layout shown in FIG. 2) which can be viewed as a variation of a hybrid superconductor-semiconductor quantum device that has multiple segments of different lengths. Using the experimental hybrid mobility device, one can measure the nonlocal conductance (G_{RL}) for different physical lengths (L), and then extract the electron localization length (l_{loc}) in the semiconductor. Plots 300 show the experimentally measured nonlocal conductance across sections of lengths L=1 μm, 2 μm, 3 μm, 4 μm, 6 μm, and 8 μm in the same wire versus the plunger voltage (V_{plunger} [V]) and the bias voltage (V_{bias} [mV]) for the different length values. At around V_{plunger}=−1.185 V, the nonlocal conductance of the 1 μm wire becomes larger than 0.05e²/h. The onset of nonlocal conductance appearing around this gate voltage (V_{plunger}=−1.185 V) for multiple wire lengths suggests that this signifies the onset of the first sub-band (indicated by the dotted lines). These lengths are chosen as examples in this measurement and are not intended to limit the application of the systems and methods described herein to devices with different wire lengths.

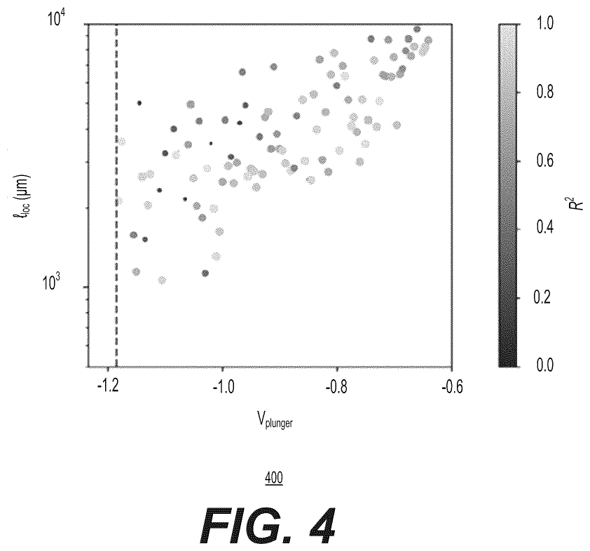

FIG. 4 shows a graph 400 of the extracted localization lengths (l_{loc}) as a function of the plunger voltage (V_{plunger}). The localization lengths are extracted by averaging the nonlocal conductance over a small bias window (e.g., ±20 μeV). The localization length is then extracted by fitting the data to the expected value of the typical conductance ((−G_{RL}/√G_{RR}G_{LL})=A exp(−2 L/l_{loc})), where G_{RR} and G_{LL} are the local conductance values, and it is assumed that the nonlocal conductance decays with the increase in length L.

In certain devices, the junctions can attenuate the nonlocal conductance signal, which complicates the relationship between the extracted localization lengths and the nonlocal conductance. The complication arises from the fact that the part of nonlocal conductance signal is affected not only by the disorder in the transport in the semiconductor nanowire, but also by the attenuation caused by the junction itself. The attenuation caused by the junction itself has a random component to it. To remove the effect of the junction attenuation, in one example, the nonlocal conductance signal is normalized by the square root of the product of the local conductance values (N=√G_{RR}G_{LL}). The attenuation of the signal due to the junctions is equal to the attenuation of the nonlocal conductance. By defining a new quantity B=G_{nonlocal}/N, which is invariant to changes in the junction transparency, the localization lengths can be estimated as described further. The normalization may be performed selectively depending upon whether the junction is open or closed. This is because the effect of the attenuation caused by the junction varies depending upon whether the junction is closed or open. Broadly speaking, the opening of a junction reduces the attenuation caused by the junction, whereas the closing of the junction increases the attenuation caused by the junction. Thus, in one example, the normalization may be performed when the measurements are being performed with a closed junction, but no normalization may be performed when the measurements are being performed with an open junction.

With continued reference to FIG. 4, the fit parameters can be obtained by linear fit of ln(−G_{RL}) vs. L with R² describing the quality of the fit. Graph 400 shows the extracted localization lengths (l_{loc}) as a function of the plunger voltage (V_{plunger}) with the quality of the fit R² on the right side of graph 400. Alternatively, as part of generating graph 400, during fitting the data to the expected value of the conductance, conductance ((−G_{RL})=A exp(−2 L/l_{loc})) can also be used.

As shown in graph 400 of FIG. 4, the extracted localization lengths (l_{loc}) have a high variance. This variance can be explained, in part, by the statistical error caused by the small set of observations (device lengths L) available at each of the plunger voltage (V_{plunger}) values. In addition, some of this variance may be since the signal is exponentially suppressed in L because for long devices, the estimated localization length (l_{loc}, which is also referred to as/in the equations described further) is dominated by noise. Thus, in one example, the measured conductance can be modeled as y=e∧+ε, where ∧ is represented as

$$Λ \sim 𝒩 ( \frac{- 2 L}{l} , \frac{4 L}{l} )$$

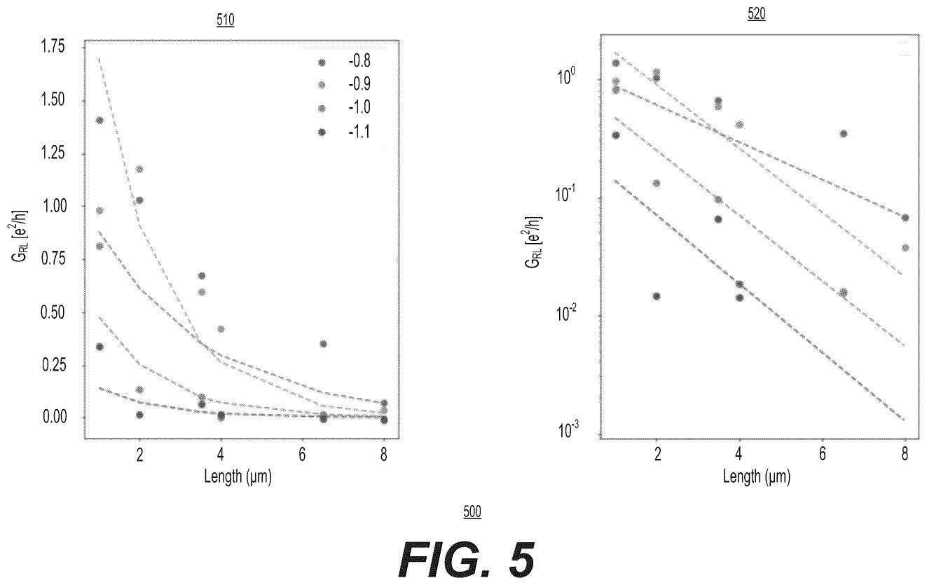

and ε is represented as ε˜N(0, σ²). FIG. 5 shows a graph 510 of extracted localization lengths and a graph 520 of log of the extracted localization lengths.

The measurement of the nonlocal conductance for different device lengths should enable the estimation of the localization length (LL). In practice, the measurements of the nonlocal conductance are corrupted by noise. To address these limitations, the statistical model specifying the relation of the measured nonlocal conductance values and the device lengths is provided implicitly (e.g., as a stochastic generative model). For many types of statistical estimation (e.g., maximum likelihood and Bayesian), one needs access to the likelihood function. In this case, however, there is no functional form available for the likelihood approach.

To address this issue, an algorithm based on numerical integration to compute high-precision estimates of the likelihood is used. Models of hybrid superconductor-semiconductor quantum device in both the open and closed regimes, with the difference between the two cases predicated on differences in the generative models, are described. For the open regime, the true device conductance is modelled as a log-normal variate whose underlying mean and variance parameters vary linearly in device length at a rate inverse to the localization length. While in the closed regime, an additional step of multiplication by a random phase factor is hypothesized. In both cases, Gaussian measurement noise is added to the true conductance during measurement.

As described above, the likelihood alone can be used to extract the localization length at each device gate setting independently, by finding the values that maximize the log likelihood. While this approach, with the measured conductance model described earlier, provides useful information quite rapidly, it still yields estimates with some imprecision. This is because the number of device lengths with which to perform measurements is small and it still impacts the likelihood-based extraction of localization lengths. To address this issue, the present disclosure further describes a joint prior distribution over the localization lengths. As part of the equations with respect to the description related to the smoothing of the extracted localization length, the localization length is abbreviated as l (lowercase L).

To mitigate the issue of the large parameter variance when performing independent localization length estimation, a prior distribution enforcing uniform smoothness over the gate voltage vs the localization length function is described. In conjunction with the likelihood computation described earlier, a Bayesian Max a Posteriori (MAP) estimate is used to recover the localization lengths with improved accuracy. In one example, the prior distribution enforcing uniform smoothness over the gate voltage vs the localization length function is derived from two types of local prior knowledge concerning the extracted localization length estimates. The local prior knowledge includes bounds on the parameter values and relates to the prior marginal density whose shape represents prior knowledge. In one example, the joint prior distribution relates to the knowledge that the localization length varies smoothly with the change in the plunger voltage (V_{plunger}) values. The joint prior knowledge also has a structural assumption that assumes that the smoothing level is a bias-variance tradeoff.

The joint prior distribution is constructed by starting with the independent prior, in which the distribution over localization lengths is assumed to be a product over the marginal localization length priors and adding a set of absolute value constraints onto the joint prior support such that the rate of change, or a second derivative of the function, is restricted to some specifiable maximum value. Each absolute value constraint is translated into two linear inequality constraints, and for a given level of smoothing, the Bayesian Max a Posteriori (MAP) estimate is obtained using a constrained optimization algorithm.

Table 1 below summarizes the Bayesian method and the MAP estimation.

TABLE 1
Prior
π(l, σ²) = π(l)π(σ²),
Likelihood
$f ( y \vert l , σ ) = {\prod }_{i = 1}^{K} f ( {y}_{i} \vert {l}_{i} , {σ}_{i}^{2} )$
Bayesian inference
Posterior density: π(1, σ²|y) ∝ π(1, σ²)f(y|l, σ)
Posterior mean: [symbol] [l, σ²|y]
Max a Posteriori (MAP): arg max_{1,σ}_{²} logπ(l, σ²) + logf(y|l, σ)

The goal of the Bayesian method shown in Table 1 is to infer the localization length and the noise variance, which are assumed to be independent of each other. In other words, the priors for the two together can be expressed with the product of the two individually. The posterior density in Table 1 is proportional to this product. Moreover, the distributions for both the localization length and the noise are assumed to be high dimensional because for every one of the plunger voltage values there are extracted localization length values, which relate to the dimension of the problem. To obtain the likelihood of a prior, one can either take the posterior mean estimation (shown in Table 1 above) or take the Max a Posteriori (MAP) estimation (also shown in Table 1 above).

One example of a derivation of likelihood that can be used as part of the Bayesian method of Table 1 is shown in Table 2 below. The integral shown in equation 1 (Eq. 1) below can be computed using the numerical quadrature integration methods.

TABLE 2

| | |
|---|---|
| $( y \vert l , {σ}^{2} , L , V ) = \frac{1}{4 π} \sqrt{\frac{l}{L {σ}^{2}}} {\int }_{- ∞}^{∞} {e}^{h ( y , t )} dt$ $h ( y , t ) = - \frac{1}{2 {σ}^{2}} {( exp ( t ) - y )}^{2} - \frac{l}{8 L} {( t + \frac{2 L}{l} )}^{2}$ | (Eq. 1) (Eq. 2) |

Numerical computation of the log likelihood requires numerical integration at each observed data point (conductance). When performing Bayesian MAP estimation, these integrations must be performed at each step in the optimization routine maximizing the posterior log probability. While this is reasonable in some cases, for example the open regime model, it can become prohibitively expensive for the closed regime where the log likelihood involves double integration. To mitigate this issue, an interpolation table of log likelihood values is computed offline for an experimental setting of interest (e.g., the range of device lengths, and the hypothesized ranges of localization length and noise variance). The table of log likelihoods is computed using the expensive numerical integration methods, but once completed it can be used to produce fast and accurate estimates of the log likelihood of an observation at any parameter setting using, for example, cubic or quintic interpolation. As an example, the computed table of log likelihoods can be stored in memory 120 of computing system 100 of FIG. 1 described earlier. Calculation code 126 can be modified to use the cubic or quintic interpolation instead of the more expensive numerical integration methods. Advantageously, when used in the localization length MAP routine, this strategy can accelerate the estimation by many orders of magnitude over the direct computation of the integrals shown in Eq. 1 of Table 2 above.

As explained earlier, the prior distribution enforcing uniform smoothness over the gate voltage vs the localization length function is derived from two types of local prior knowledge concerning the extracted localization length estimates. The first type of local prior knowledge relates to the bounds on the parameter values. Table 3 below shows one example of applying a marginal prior, that relates to the fact that the localization length for every one of the parameters being estimated is the same.

TABLE 3
Assume for all i,
πᵢ(lᵢ) = p(lᵢ)
πᵢ(σᵢ²) = q(σᵢ²)
Log-uniform (or reciprocal) prior:
loglᵢ ~ [symbol] [a, b]
or equivalently:
$p ( {l}_{i} ) ∝ \frac{1}{{l}_{i}} for {l}_{i} ∈ [ {e}^{a} , {e}^{b} ]$
Independent MAP estimates:
\hat{l}ᵢ, \hat{σ}ᵢ² = arg maxₗ_{ᵢ}_{,σ}_{ᵢ}_{²}logp(lᵢ) + logq(σᵢ²) + logf(yᵢ|lᵢ, σᵢ²)

In addition to the marginal prior described above with respect to Table 3, one can also apply a smoothness prior on the localization length, as shown below in Table 4.

TABLE 4

Stationary model: π(lᵢ) = ∫ₗ₋ᵢ π(l)dl₋ᵢ = p(lᵢ)
However, the lengths are correlated: π(l) ≠ Πᵢ p(lᵢ)

Despite using a marginal prior that relates to the fact that the localization length for every one of the parameters being estimated is the same value (e.g., Table 3) and using the smoothness prior (e.g., Table 4) described earlier, the localization length estimates can still be improved by the application of the mean free path prior.

Table 5 shows various aspects associated with the application of the mean free path prior.

TABLE 5
Mean free path prior:

| | |
|---|---|
| $π ( l ) ∝ {\prod }_{i} p ( {l}_{i} ) subject to$ ${l}_{i} ∈ [ s , t ]$ $\vert {l}_{i + 1} - 2 {l}_{i} + {l}_{i - 1} \vert \leq {c}_{2}$ | (Eq. 1) |

Smoothness over log localization lengths can also be enforced using the
following prior:
|loglᵢ₊₁ − 2loglᵢ + loglᵢ₋₁| ≤ c2

The mean free path prior described in Table 5 is based on the observation that if one evaluates any two neighboring localization lengths with respect to the plunger voltage scan (described earlier), and if one compares the localization length (lᵢ) for the i^{th} point, the localization length (lᵢ₊₁) for the (i+1)^{th} point, and the localization length (lᵢ₋₁) for the (i−1)^{th} point, and then calculates an absolute value of the linear function (Eq. 1 of Table 5), then that absolute value has to be less than or equal to a specified value for the parameter c₂ in Table 5. In other words, the argument of the absolute value constraints an approximation to the second derivative. The mean free path prior can also be viewed as providing a constraint imposed by a convex polytope. The effect of the mean free path prior is similar to a smoothing spline function, but stronger. The constraints described above with respect to Table 5 impose a uniform bound on the smoothness of the localization length estimates. A larger value for the parameter c₂ implies less smoothing. For a given value of the parameter c₂, one can solve the full Max a Posteriori (MAP) problem using a constrained optimization software.

While the maximum likelihood estimation of localization lengths has certain advantages over the exponential fitting method, the localization length estimates are still noisy. Advantageously, the use of the priors over the likelihood not only allows one to calculate the parameter estimates in isolation, and in a different way, but also lets one use different priors to get better localization length estimates.

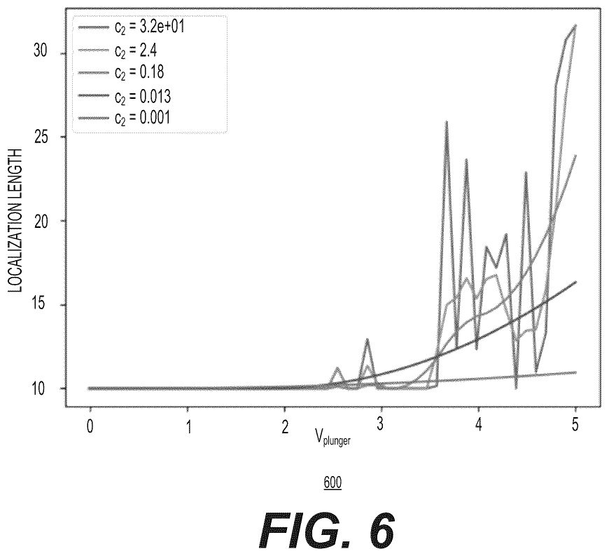

FIG. 6 shows a graph 600 created with synthetic data to illustrate the effect of the mean path prior smoothing. The synthetic data relates to localization lengths versus the plunger voltage using log normal data with added noise. The various curves in graph 600 are then generated by applying the Max a Posteriori (MAP) function with the priors discussed earlier, including the mean free path prior with different values for the parameter c₂. Graph 600 shows that smaller values for the parameter c₂ result in more smoothing. In other words, as one starts to make the parameter c₂ progressively smaller, imposing higher smoothness, the estimated localization lengths begin to look like a quadratic function of the plunger voltage (V_{plunger}) values.

In one example, the value of the parameter c₂ described with respect to the mean free path prior can be selected using 2-fold cross-validation, as shown in Table 6 below. The appropriate level of smoothing is automatically determined by cross-validation. In other words, for any smoothing level, a subset of the data is used to estimate the localization lengths, while a complementary subset is used to check the fit, and the smoothing level yielding the best validation fit is selected. Table 6 shows an example of the 2-fold cross-validation process using an even set of data comprising even values of the estimated localization lengths and an odd set of data comprising odd values of the estimated localization lengths. The validation loss is defined as the average of the losses from the two complementary sets of data (the even set of data and the odd set of data).

TABLE 6
Cross-validation [symbol]
= {(yᵢⱼ, Vᵢ)|i ∈ Sₑ} [symbol]
= {(yᵢⱼ, Vᵢ)|i ∈ Sₒ}
\hat{l}ₑ, \hat{σ}ₑ² = arg max_{l,σ}_{²} [logf(1, σ²| [symbol] , c₂)]
\hat{l}ₒ, \hat{σ}ₑ² = arg max_{l,σ}_{²} [logf(1, σ²| [symbol] , c₂)]
Validation loss:
${ℒ}^{val} = \frac{{ℒ}^{{val}_{o}} + {ℒ}^{{val}_{e}}}{2}$

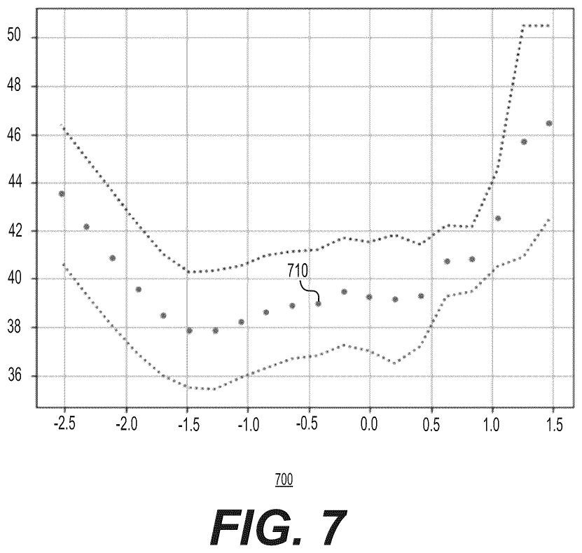

The validation losses can be calculated by performing the localization length estimation for different log values of the parameter c₂ using the even data alone and then performing the localization length estimation for different log values of the parameter c₂ using the odd data alone. FIG. 7 shows a graph 700 illustrating the validation losses for log values of the constraint parameter (c₂) for even data alone and for odd data alone. Curve 710 formed by the series of dots shows the average validation loss. The parameter value c₂ that results in the minimum average validation loss is selected for use with the mean free path prior described earlier.

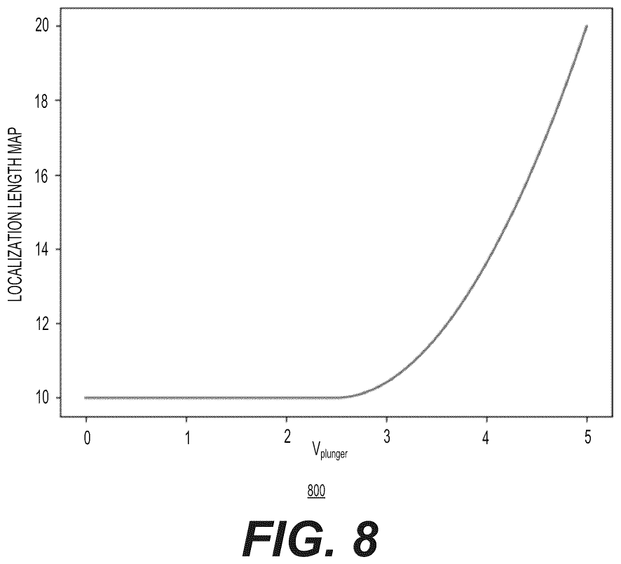

FIG. 8 shows a graph 800 illustrating the estimated localization length using the Max a Posteriori (MAP) function versus the plunger voltage scan using the selected parameter value c₂. As shown in graph 800, the localization lengths extracted with the Max a Posteriori (MAP) function with the priors, including the mean free path prior with the selected parameter value c₂, produces highly accurate estimated localization lengths as a function of the plunger voltage (V_{plunger}) values.

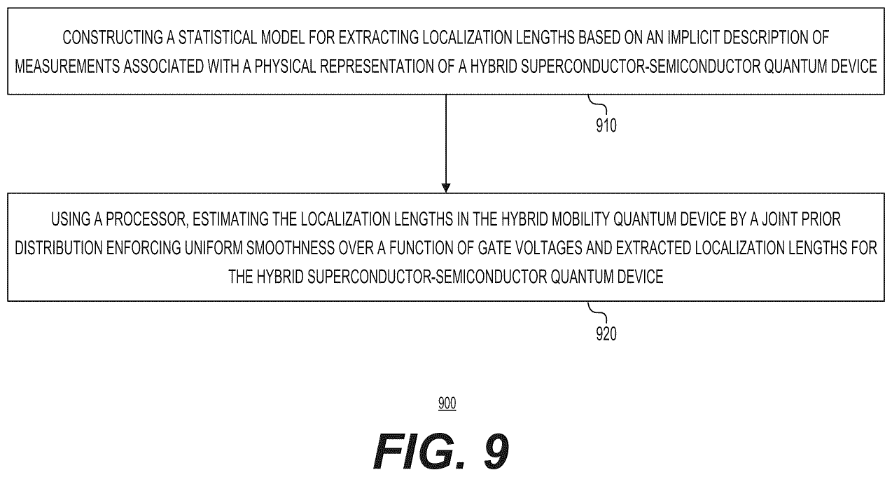

FIG. 9 shows a flow chart 900 of a method for estimating localization lengths in hybrid superconductor-semiconductor quantum devices in accordance with one example. The steps associated with this method may be performed using instructions (e.g., the various code blocks) stored in memory 120 of computing system 100 of FIG. 1. Step 910 includes constructing a statistical model for extracting localization lengths based on an implicit description of measurements associated with a physical representation of the hybrid superconductor-semiconductor quantum device. FIGS. 2-4, and the related description, provide additional details for obtaining measured nonlocal conductance values and then using these obtained values to construct a statistical model for the extracted localization lengths. As explained earlier, in one example, the measurements associated with the physical representation of the hybrid superconductor-semiconductor quantum device comprise physical measurements of conductance for a set of device lengths. Other techniques can also be used to construct a statistical model for extracting localization lengths based on an implicit description of the measurements associated with a physical representation of the hybrid superconductor-semiconductor quantum device.

Step 920 includes estimating the localization lengths in the hybrid superconductor-semiconductor quantum device by a joint prior distribution enforcing uniform smoothness over a function of gate voltages and extracted localization lengths for the hybrid superconductor-semiconductor quantum device. As explained earlier, the joint prior distribution is constructed by starting with independent local priors, in which a distribution over the localization lengths is assumed to be a product of the independent local priors, and adding one or more of a set of constraints onto the joint prior distribution such that a rate of change of the function is restricted to a specified maximum value. As explained earlier the appropriate level of the uniform smoothness may be determined by cross-validating complementary subsets of data (e.g., even vs. odd localization lengths) related to the extracted localization lengths.

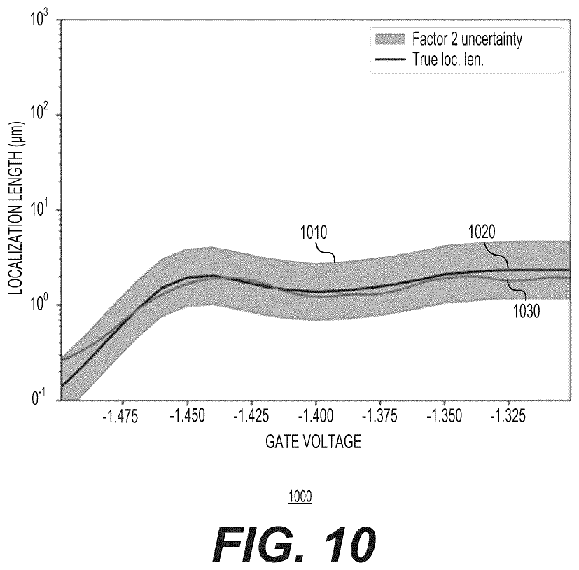

FIG. 10 shows a graph 1000 comparing the smoothed and the validated localization lengths with the localization lengths obtained from a physics-based simulator. Envelope 1010 relates to a factor 2 uncertainty. Curve 1020 shows the localization lengths derived from the physics-based simulator. Curve 1030 shows the smoothed and the validated localization lengths obtained using the methods described herein.

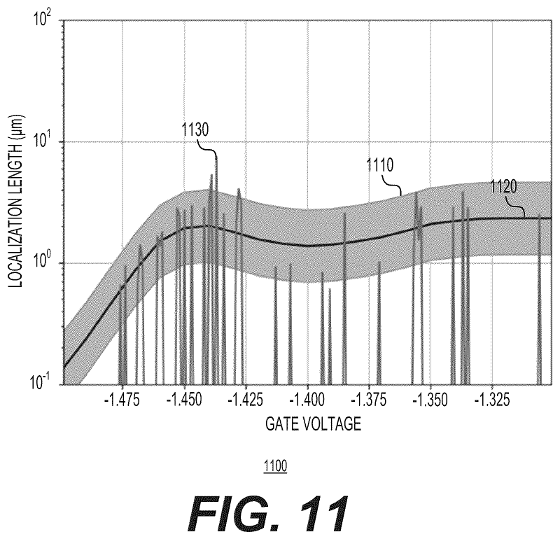

FIG. 11 shows a graph 1100 comparing the localization lengths obtained using an independent Max a Posteriori (MAP) function (without the smoothing and validation) with the localization lengths obtained from a physics-based simulator. Envelop 1110 relates to a factor 2 uncertainty. Curve 1120 shows the localization lengths derived from the physics-based simulator. The uneven distribution 1130 corresponds to the localization lengths obtained using an independent Max a Posteriori (MAP) function (without the smoothing and validation). As shown in FIG. 11, the localization length estimates obtained without the smoothing and validation compare poorly with the localization lengths derived from the physics-based simulator. Notably, the localization lengths obtained using the Max a Posteriori (MAP) function (without the smoothing and validation) are not smooth and are different from the localization lengths derived from the physics-based simulator.

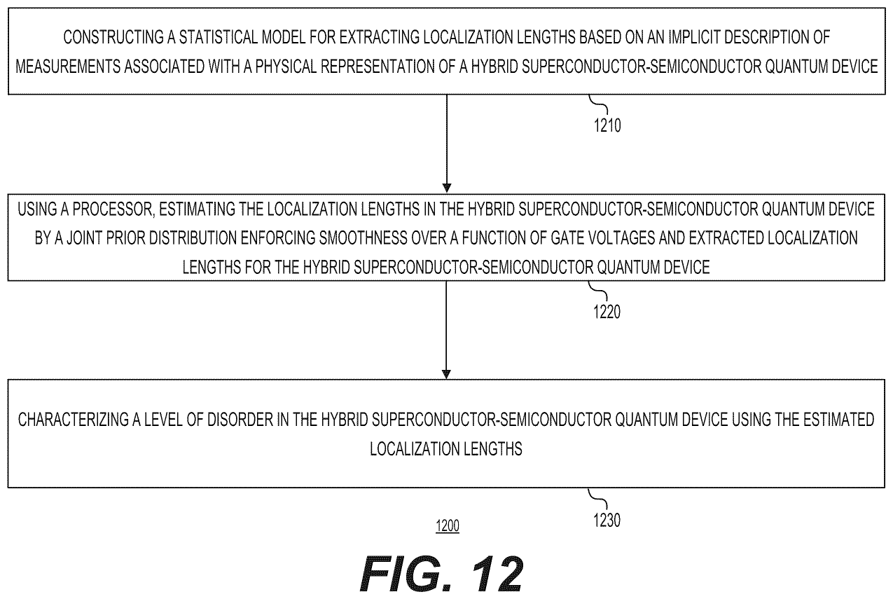

FIG. 12 shows a flow chart 1200 of a method for characterizing a level of disorder in hybrid superconductor-semiconductor quantum devices in accordance with one example. The steps associated with this method may be performed using instructions (e.g., the various code blocks) stored in memory 120 of computing system 100 of FIG. 1. Step 1210 includes constructing a statistical model for extracting localization lengths based on an implicit description of measurements associated with a physical representation of the hybrid superconductor-semiconductor quantum device. FIGS. 2-4, and the related description, provide additional details for obtaining measured nonlocal conductance values and then using these obtained values to construct a statistical model for the extracted localization lengths. As explained earlier, in one example, the measurements associated with the physical representation of the hybrid superconductor-semiconductor quantum device comprise physical measurements of conductance for a set of device lengths. Other techniques can also be used to construct a statistical model for extracting localization lengths based on an implicit description of the measurements associated with a physical representation of the hybrid superconductor-semiconductor quantum device.

Step 1220 includes estimating the localization lengths in the hybrid superconductor-semiconductor quantum device by a joint prior distribution enforcing smoothness over a function of gate voltages and localization lengths for the hybrid superconductor-semiconductor quantum device. As explained earlier, the joint prior distribution is constructed by starting with independent local priors, in which a distribution over the localization lengths is assumed to be a product of the independent local priors, and adding one or more of a set of constraints onto the joint prior distribution such that a rate of change of the function is restricted to a specified maximum value. As explained earlier the appropriate level of the uniform smoothness may be determined by cross-validating complementary subsets of data (e.g., even vs. odd localization lengths) related to the extracted localization lengths.

Step 1230 comprises characterizing a level of disorder in the hybrid superconductor-semiconductor quantum device using the estimated localization lengths. As noted earlier, the disorder in the bulk of superconducting wires associated with the hybrid superconductor-semiconductor quantum devices suppresses the topological gap and increases the coherence length. This, in turn, leads to a minimum length requirement for the superconducting wire to perform well as a part of a qubit that depends on the composition/geometry of the stack of layers used to form the wire and the disorder level. In the topological phase, the coherence length corresponds to the localization length of a Majorana zero mode (MZM). In the topological phase, when the disorder is very weak, the localization length approaches the localization length of a perfectly clean system, which has no states below the clean topological gap, apart from the MZMs. Increased disorder elongates the localization length in the topological phase and shortens it in the trivial phase. In sum, the estimated localization lengths derived from step 1220 can be used to characterize the level of disorder in the hybrid superconductor-semiconductor quantum device. As an example, calculation code 126 stored in memory 120 of computing system 100 may be used to characterize the level of disorder based on the estimated localization lengths.

In conclusion, the present disclosure relates to method for estimating localization lengths in a hybrid superconductor-semiconductor quantum device. The method may include constructing a statistical model for extracting localization lengths based on an implicit description of nonlocal conductance measurements associated with a physical representation of the hybrid superconductor-semiconductor quantum device.

The method may further include, using a processor, estimating the localization lengths in the hybrid superconductor-semiconductor quantum device by a joint prior distribution enforcing smoothness over a function of gate voltages and extracted localization lengths for the hybrid superconductor-semiconductor quantum device.

The statistical model may comprise estimates of likelihood that are used to extract localization lengths at each of the gate voltages independently. The joint prior distribution may be constructed by starting with independent local priors, in which a distribution over the extracted localization lengths is assumed to be a product of the independent local priors, and adding one or more of a set of constraints onto the joint prior distribution such that a rate of change of the function is restricted to a specified maximum value. The independent local priors may include a marginal prior with respect to values of the extracted localization lengths, a smoothness prior with respect to correlation among the values of the extracted localization lengths, and a mean free path prior with respect to values of neighboring extracted localization lengths.

As part of this method, an appropriate level of the smoothness may be determined by cross-validating complementary subsets of data related to the extracted localization lengths. The complementary subsets may comprise a first subset of data including odd values of the extracted localization lengths and a second subset of data including even values of the extracted localization lengths. The implicit measurements associated with the physical representation of the hybrid superconductor-semiconductor quantum device may correspond to physical measurements of nonlocal conductance values. The measured nonlocal conductance values may be selectively normalized to remove an effect of junction attenuation caused by a respective junction depending on whether the physical measurements of the nonlocal conductance values are performed when the respective junction is open or closed.

In another example, the present disclosure relates to a non-transitory computer-readable medium comprising instructions for a method for estimating localization lengths in a hybrid superconductor-semiconductor quantum device. The method may include constructing a statistical model for extracting localization lengths based on an implicit description of measurements associated with a physical representation of the hybrid superconductor-semiconductor quantum device, where the measurements associated with the physical representation of the hybrid superconductor-semiconductor quantum device comprise physical measurements of nonlocal conductance values for a set of device lengths.

The method may further include using a processor, estimating the localization lengths in the hybrid superconductor-semiconductor quantum device by a joint prior distribution enforcing smoothness over a function of gate voltages and extracted localization lengths for the hybrid superconductor-semiconductor quantum device. The statistical model may comprise estimates of likelihood that are used to extract localization lengths at each of the gate voltages independently.

The joint prior distribution may be constructed by starting with independent local priors, in which a distribution over the extracted localization lengths is assumed to be a product of the independent local priors, and adding one or more of a set of constraints onto the joint prior distribution such that a rate of change of the function is restricted to a specified maximum value. The independent local priors may include a marginal prior with respect to values of the extracted localization lengths, a smoothness prior with respect to correlation among the values of the extracted localization lengths, and a mean free path prior with respect to values of neighboring extracted localization lengths.

As part of the method, an appropriate level of the smoothness is determined by cross-validating complementary subsets of data related to the extracted localization lengths. The complementary subsets may comprise a first subset of data including odd values of the extracted localization lengths and a second subset of data including even values of the extracted localization lengths. The measured nonlocal conductance values may be selectively normalized to remove an effect of junction attenuation caused by a respective junction depending on whether the physical measurements of the nonlocal conductance values are performed when the respective junction is open or closed.

In yet another example, the present disclosure relates to a method for estimating localization lengths in a hybrid superconductor-semiconductor quantum device. The method may further include constructing a statistical model for extracting localization lengths based on an implicit description of measurements associated with a physical representation of the hybrid superconductor-semiconductor quantum device.

The method may further include using a processor, estimating the localization lengths in the hybrid superconductor-semiconductor quantum device by a joint prior distribution enforcing smoothness over a function of gate voltages and extracted localization lengths for the hybrid superconductor-semiconductor quantum device. The method may further include characterizing a level of disorder in the hybrid superconductor-semiconductor quantum device using the estimated localization lengths.

As part of this method, the statistical model may comprise estimates of likelihood that are used to extract localization lengths at each of the gate voltages independently. The joint prior distribution may be constructed by starting with independent local priors, in which a distribution over the extracted localization lengths is assumed to be a product of the independent local priors, and adding one or more of a set of constraints onto the joint prior distribution such that a rate of change of the function is restricted to a specified maximum value. The independent local priors may include a marginal prior with respect to values of the extracted localization lengths, a smoothness prior with respect to correlation among the values of the extracted localization lengths, and a mean free path prior with respect to values of neighboring extracted localization lengths.

As part of the method, an appropriate level of the smoothness may be determined by cross-validating complementary subsets of data related to the extracted localization lengths, and where the complementary subsets comprise a first subset of data including odd values of the extracted localization lengths and a second subset of data including even values of the extracted localization lengths. The implicit measurements associated with the physical representation of the hybrid superconductor-semiconductor quantum device may correspond to physical measurements of nonlocal conductance values, and where the measured nonlocal conductance values are selectively normalized to remove an effect of junction attenuation caused by a respective junction depending on whether the physical measurements of the nonlocal conductance values are performed when the respective junction is open or closed.

It is to be understood that the systems, devices, methods, and components described herein are merely examples. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a device, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed:

1. A method for estimating localization lengths in a hybrid superconductor-semiconductor quantum device, the method comprising:
constructing a statistical model for extracting localization lengths based on an implicit description of nonlocal conductance measurements associated with a physical representation of the hybrid superconductor-semiconductor quantum device; and
using a processor, estimating the localization lengths in the hybrid superconductor-semiconductor quantum device by a joint prior distribution enforcing smoothness over a function of gate voltages and extracted localization lengths for the hybrid superconductor-semiconductor quantum device.

2. The method of claim 1, wherein the statistical model comprises estimates of likelihood that are used to extract localization lengths at each of the gate voltages independently.

3. The method of claim 1, wherein the joint prior distribution is constructed by starting with independent local priors, in which a distribution over the extracted localization lengths is assumed to be a product of the independent local priors, and adding one or more of a set of constraints onto the joint prior distribution such that a rate of change of the function is restricted to a specified maximum value.

4. The method of claim 3, wherein the independent local priors include a marginal prior with respect to values of the extracted localization lengths, a smoothness prior with respect to correlation among the values of the extracted localization lengths, and a mean free path prior with respect to values of neighboring extracted localization lengths.

5. The method of claim 1, wherein an appropriate level of the smoothness is determined by cross-validating complementary subsets of data related to the extracted localization lengths.

6. The method of claim 5, wherein the complementary subsets comprise a first subset of data including odd values of the extracted localization lengths and a second subset of data including even values of the extracted localization lengths.

7. The method of claim 1, wherein the implicit measurements associated with the physical representation of the hybrid superconductor-semiconductor quantum device correspond to physical measurements of nonlocal conductance values, and wherein the measured nonlocal conductance values are selectively normalized to remove an effect of junction attenuation caused by a respective junction depending on whether the physical measurements of the nonlocal conductance values are performed when the respective junction is open or closed.

8. A non-transitory computer-readable medium comprising instructions for a method for estimating localization lengths in a hybrid superconductor-semiconductor quantum device, the method comprising:
constructing a statistical model for extracting localization lengths based on an implicit description of measurements associated with a physical representation of the hybrid superconductor-semiconductor quantum device, wherein the measurements associated with the physical representation of the hybrid superconductor-semiconductor quantum device correspond to physical measurements of nonlocal conductance values for a set of device lengths; and
using a processor, estimating the localization lengths in the hybrid superconductor-semiconductor quantum device by a joint prior distribution enforcing smoothness over a function of gate voltages and extracted localization lengths for the hybrid superconductor-semiconductor quantum device.

9. The non-transitory computer-readable medium of claim 8, wherein the statistical model comprises estimates of likelihood that are used to extract localization lengths at each of the gate voltages independently.

10. The non-transitory computer-readable medium of claim 8, wherein the joint prior distribution is constructed by starting with independent local priors, in which a distribution over the extracted localization lengths is assumed to be a product of the independent local priors, and adding one or more of a set of constraints onto the joint prior distribution such that a rate of change of the function is restricted to a specified maximum value.

11. The non-transitory computer-readable medium of claim 10, wherein the independent local priors include a marginal prior with respect to values of the extracted localization lengths, a smoothness prior with respect to correlation among the values of the extracted localization lengths, and a mean free path prior with respect to values of neighboring extracted localization lengths.

12. The non-transitory computer-readable medium of claim 8, wherein an appropriate level of the smoothness is determined by cross-validating complementary subsets of data related to the extracted localization lengths.

13. The non-transitory computer-readable medium of claim 12, wherein the complementary subsets comprise a first subset of data including odd values of the extracted localization lengths and a second subset of data including even values of the extracted localization lengths.

14. The non-transitory computer-readable medium of claim 8, wherein the measured nonlocal conductance values are selectively normalized to remove an effect of junction attenuation caused by a respective junction depending on whether the physical measurements of the nonlocal conductance values are performed when the respective junction is open or closed.

15. A method for estimating localization lengths in a hybrid superconductor-semiconductor quantum device, the method comprising:
constructing a statistical model for extracting localization lengths based on an implicit description of measurements associated with a physical representation of the hybrid superconductor-semiconductor quantum device;
using a processor, estimating the localization lengths in the hybrid superconductor-semiconductor quantum device by a joint prior distribution enforcing smoothness over a function of gate voltages and extracted localization lengths for the hybrid superconductor-semiconductor quantum device; and
characterizing a level of disorder in the hybrid superconductor-semiconductor quantum device using the estimated localization lengths.

16. The method of claim 15, wherein the statistical model comprises estimates of likelihood that are used to extract localization lengths at each of the gate voltages independently.

17. The method of claim 15, wherein the joint prior distribution is constructed by starting with independent local priors, in which a distribution over the extracted localization lengths is assumed to be a product of the independent local priors, and adding one or more of a set of constraints onto the joint prior distribution such that a rate of change of the function is restricted to a specified maximum value.

18. The method of claim 17, wherein the independent local priors include a marginal prior with respect to values of the extracted localization lengths, a smoothness prior with respect to correlation among the values of the extracted localization lengths, and a mean free path prior with respect to values of neighboring extracted localization lengths.

19. The method of claim 15, wherein an appropriate level of the smoothness is determined by cross-validating complementary subsets of data related to the extracted localization lengths, and wherein the complementary subsets comprise a first subset of data including odd values of the extracted localization lengths and a second subset of data including even values of the extracted localization lengths.

20. The method of claim 15, wherein the implicit measurements associated with the physical representation of the hybrid superconductor-semiconductor quantum device correspond to physical measurements of nonlocal conductance values, and wherein the measured nonlocal conductance values are selectively normalized to remove an effect of junction attenuation caused by a respective junction depending on whether the physical measurements of the nonlocal conductance values are performed when the respective junction is open or closed.
